(19) United States
(12) Patent Application Publication
(10) Pub. No.: US 2014/0214393 A1
(43) Pub. Date: Jul. 31, 2014

(54) SYSTEM AND METHOD FOR PERFORMING DISTRIBUTED SIMULATION

(71) Applicant: Electronics and Telecommunications Research Institute, Daejeon-city (KR)

(72) Inventors: Jin-Myoung KIM, Daejeon (KR); Hae-Young LEE, Seoul (KR); In-Geol CHUN, Seoul (KR); Won-Tae KIM, Chungcheongnam-do (KR)

(73) Assignee: Electronics and Telecommunications Research Institute, Daejeon-city (KR)

(21) Appl. No.: 14/102,057

(22) Filed: Dec. 10, 2013

(30) Foreign Application Priority Data
Jan. 31, 2013 (KR) 10-2013-0011463

(51) Int. Cl. G06F 17/50

(52) U.S. Cl. CPC G06F 17/5009
USPC 703/13

(57) ABSTRACT

Disclosed herein are an apparatus and method of performing distributed simulation. In the method of performing distributed simulation, a simulation time provision apparatus sets global simulation times synchronized with real times based on the real times. The simulation time provision apparatus distributes the set global simulation times over distributed simulators. Each of the distributed simulators adjusts the interval between local simulation times, during which the continuous or discrete elements of an allocated one of subsystem models that model subsystems forming a hybrid system will be analyzed, based on the global simulation times. The distributed simulator performs simulation to analyze the continuous or discrete elements of the subsystem model during a period corresponding to the adjusted interval between the local simulation times.

### CROSS REFERENCE TO RELATED APPLICATION

This application claims the benefit of Korean Patent Application No. 10-2013-0011463, filed on Jan. 31, 2013, which is hereby incorporated by reference in its entirety into this application.

### BACKGROUND OF THE INVENTION

1. Technical Field

The present invention relates generally to a system and method for performing distributed simulation in order to verify the reliability of a hybrid system and, more particularly, to a system and method for performing distributed simulation, which, upon performing distributed simulation on subsystem models that model subsystems that form a hybrid system, such as a Cyber Physical System (CPS), having both the characteristics of a physical element and the characteristics of a computational element, using a plurality of distributed simulators, provide the plurality of distributed simulators with global simulation time synchronized based on real time, and cause the plurality of distributed simulators to adjust their local simulation time based on the synchronized global simulation time and to then perform simulations on respective subsystem models allocated thereto.

2. Description of the Related Art

A CPS is a system that can guarantee software reliability, a real-time performance, and intelligence, in order to prevent unexpected errors and situations from occurring, because a real-world system is combined with a computing system and thus the complexity thereof increases. A CPS is a hybrid system in which a plurality of embedded systems have been combined with each other over a network, and has both the characteristic of a physical element and the characteristic of a computational element.

In the development of an embedded system requiring high reliability, simulation technology is widely used as an auxiliary tool for the design of a single system. Modeling for representing a system to be developed by means of an abstracted model is performed first, and then a system model is verified and modified by performing simulation using the system model. After the verification has been completed, actual hardware or software is developed based on the system model. The verification through the simulation is advantageous in that the cost or danger that accompanies the development and verification of a real system can be significantly reduced, and also, a reliable system can be developed.

Conventional simulation technologies for ensuring the validity of an embedded system model provide a hardware-in-the-loop function or a software-in-the-loop technique in which some modules of a single system model are replaced with real hardware or software and then simulation can be performed using the model. Representative products for providing these technologies include MATLAB/Simulink, LabVIEW, and Saber. These technologies can increase the validity of verification based on simulation by providing the input of an actual system to a model.

Furthermore, in order to verify the reliability of an embedded system model by performing simulation on the embedded system model, Korean Patent Application Publication No. 2011-0079856 discloses a simulation technology that is capable of predicting the real-time capability of a complicated embedded system model by performing simulation on the embedded system model with the help of a computer.

However, the conventional simulation technology for an embedded system model that is disclosed in Korean Patent Application Publication No. 2011-0079856 relates to single system simulation for the development of a single embedded system, and is problematic in that it is unsuitable for the simulation of a large-scale hybrid system, such as a CPS including various types of heterogeneous subsystems having the characteristics of a physical element or the characteristics of a computational element, and it is difficult to determine the complexity of the model when the real-time operation of a hybrid system is required.

### SUMMARY OF THE INVENTION

Accordingly, the present invention has been made keeping in mind the above problems occurring in the prior art, and an object of the present invention is to provide a distributed simulation technology that sets global simulation time having a time interval proportional to a real-time interval based on real time and distributes the set global simulation time over a plurality of distributed simulators for performing simulations on respective subsystem models that model subsystems that form a hybrid system, and thus each of the distributed simulators can adjust the interval between local simulation times, during which the continuous or discrete elements of the subsystem model allocated thereto will be analyzed, using the distributed global simulation time as synchronization time.

In accordance with an aspect of the present invention, there is provided a simulation time provision apparatus, including a global time setting unit configured to set global simulation times synchronized with real times based on the real times; and a global time distribution unit configured to distribute the global simulation times over a plurality of distributed simulators that perform simulations on respective subsystem models that model subsystems that form a hybrid system.

The global time setting unit may set the global simulation times having a specific time interval that is proportional to a real-time interval at a predetermined ratio.

Each of the plurality of distributed simulators adjusts the interval between local simulation times, during which the continuous or discrete elements of its allocated subsystem model will be analyzed, based on the global simulation times.

In accordance with another aspect of the present invention, there is provided a distributed simulator, including a local time determination unit configured to adjust the interval between local simulation times, during which the continuous or discrete elements of an allocated one of subsystem models that model subsystems forming a hybrid system will be analyzed, based on global simulation times synchronized with real times and distributed by a simulation time provision apparatus; and a simulation execution unit configured to perform simulation to analyze the continuous or discrete elements of the subsystem model during a period corresponding to the adjusted interval between the local simulation times.

The local time determination unit may adjust the interval between the global simulation times by comparing a current global simulation time distributed by the simulation time provision apparatus with a current local simulation time at which the analysis of the continuous or discrete elements, a simulation for which is scheduled to be performed at the current global simulation time, starts.

The local time determination unit may increase the interval between the global simulation times if the current local simulation time is earlier than the current global simulation time.

The local time determination unit may maintain the interval between the local simulation times if the current local simulation time is later than the current global simulation time and is earlier than a global simulation time that is distributed after the current global simulation time has been distributed.

In accordance with still another aspect of the present invention, there is provided a method of performing distributed simulation, including setting, by a simulation time provision apparatus, global simulation times synchronized with real times based on the real times; distributing, by the simulation time provision apparatus, the set global simulation times over distributed simulators; adjusting, by each of the distributed simulators, the interval between local simulation times, during which the continuous or discrete elements of an allocated one of subsystem models that model subsystems forming a hybrid system will be analyzed, based on the global simulation times; and performing, by the distributed simulator, simulation to analyze the continuous or discrete elements of the subsystem model during a period corresponding to the adjusted interval between the local simulation times.

Setting the global simulation times synchronized with the real times may include setting the global simulation times having a specific time interval that is proportional to a real-time interval at a predetermined ratio.

Distributing the set global simulation times over the distributed simulators may include distributing a current global simulation time and information about the interval between the global simulation times over the distributed simulators.

Adjusting the interval between the local simulation times may include adjusting the interval between the local simulation times by comparing the current global simulation time with a current local simulation time at which the analysis of the continuous or discrete elements, a simulation for which is scheduled to be performed at the current global simulation time, starts.

Adjusting the interval between the local simulation times may include increasing the interval between the local simulation times if the current local simulation time is earlier than the current global simulation time.

Adjusting the interval between the local simulation times may include maintaining the interval between the local simulation times if the current local simulation time is later than the current global simulation time and is earlier than a global simulation time that is distributed after the current global simulation time calculated based on the information about the interval between the global simulation times has been distributed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of a system for performing distributed simulation according to the present invention;

FIG. 2 is a block diagram showing the construction of the simulation time provision apparatus of FIG. 1;

FIG. 3 is a diagram illustrating global simulation times that are set by the simulation time provision apparatus of FIG. 1;

FIG. 4 is a block diagram showing the construction of each of the distributed simulators shown in FIG. 1;

FIG. 5 is a diagram illustrating local simulation times that are set in the distributed simulator of FIG. 1; and

FIG. 6 is a flowchart illustrating a method of performing distributed simulation according to the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily vague will be omitted below. The embodiments of the present invention are intended to fully describe the present invention to a person having ordinary knowledge in the art. Accordingly, the shapes, sizes, etc. of elements in the drawings may be exaggerated to make the description clear.

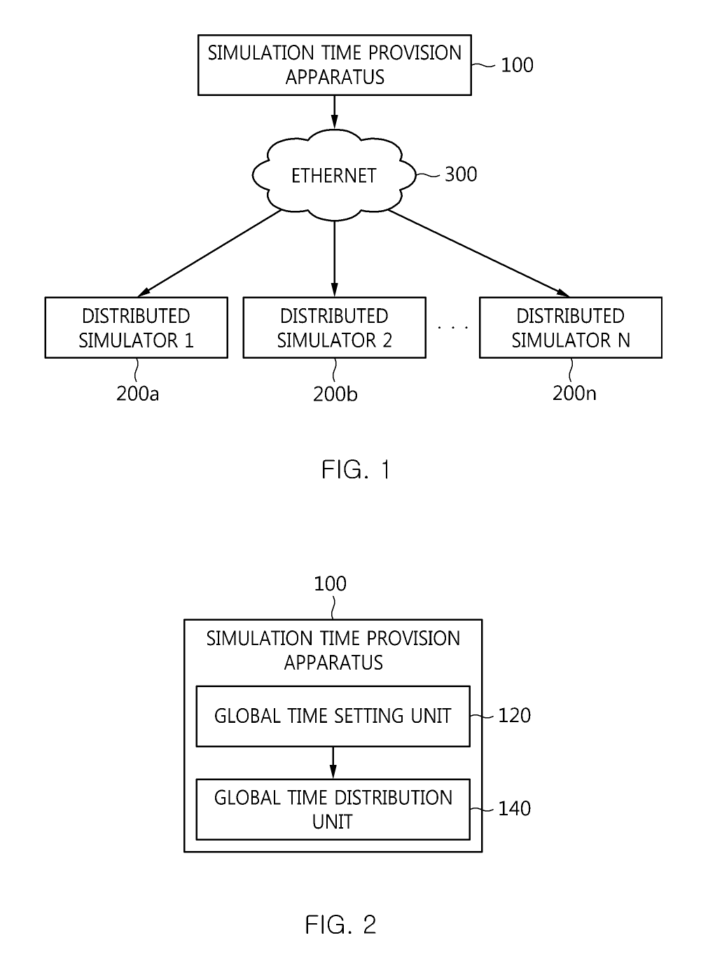

The construction and operation of a system for performing distributed simulation, including a simulation time provision apparatus and a plurality of distributed simulators, will be described below with reference to FIGS. 1 to 5.

FIG. 1 is a block diagram showing the construction of the system for performing distributed simulation according to the present invention.

Referring to FIG. 1, the system for performing distributed simulation according to the present invention includes a simulation time provision apparatus 100, and a plurality of distributed simulators 200a to 200n for performing simulations on respective models that model subsystems (hereinafter referred to as “subsystem models”) that form a hybrid system based on global simulation time provided by the simulation time provision apparatus 100.

The simulation time provision apparatus 100 sets the global simulation time synchronized with real time, and distributes the set global simulation time over the plurality of distributed simulators 200a to 200n at remote locations via an Ethernet 300. That is, in order to provide synchronized simulation time to the plurality of distributed simulators 200a to 200n, the simulation time provision apparatus 100 defines global simulation time based on real time and distributes the defined global simulation time over the plurality of distributed simulators 200a to 200n, and thus each of the distributed simulators 200a to 200n adjusts the interval between local simulation times, during which the continuous or discrete elements of a subsystem model allocated thereto will be analyzed, based on the global simulation time and performs simulation. In this case, a unit for the global simulation time which is set by the simulation time provision apparatus 100 and for the local simulation time at which each of the distributed simulators 200a to 200n performs simulation on a subsystem model allocated thereto is defined as the interval between a specific time and its subsequent time.

The plurality of distributed simulators 200a to 200n perform simulations on respective subsystem models that model subsystems that form a hybrid system, such as a CPS formed of systems in which discrete and continuous elements are mixed. When the developer of a hybrid system analyzes requirements for a system and designs the system based on the requirements, he or she verifies the designed system through simulation in order to predict problems that may occur in the designed system and remove the problems. To simulate the system at a design stage, the developer designs a hybrid system based on a model using a common system modeler. Subsystem models that model subsystems that form the hybrid system are installed on the respective distributed simulators 200a to 200n. Each of the plurality of distributed simulators 200a to 200n analyzes the continuous or discrete elements of each subsystem model allocated thereto, and performs simulation on the subsystem model based on the analyzed continuous or discrete elements. In this case, each of the plurality of distributed simulators 200a to 200n adjusts the interval between local simulation times, during which the continuous or discrete elements of the subsystem model will be analyzed, based on the global simulation time that is set and distributed by the simulation time provision apparatus 100, and then performs simulation on the subsystem model.

FIG. 2 is a block diagram showing the construction of the simulation time provision apparatus 100 of FIG. 1.

Referring to FIG. 2, the simulation time provision apparatus 100 according to the present invention includes a global time setting unit 120, and a global time distribution unit 140.

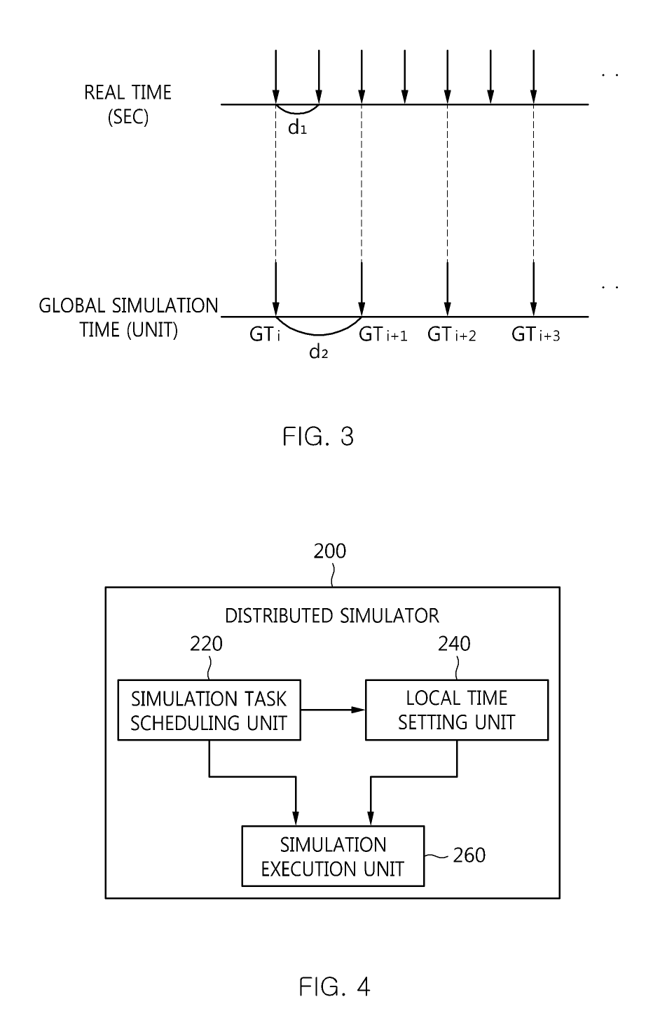

The global time setting unit 120 sets global simulation time that is synchronized with real time. The global time setting unit 120 receives the ratio of logical time to the real time from an external system or a user, and sets the global simulation time so that the global simulation time have a time interval that is proportional to a real-time interval at the received ratio of the logical time. That is, the global time setting unit 120 sets global simulation times GTᵢ, GTⁱ⁺¹, GTᵢ₊₂, GTᵢ₊₃, . . . at a time interval d₂ that is longer than the interval d₁ between real times (in this case, the real times are measured in seconds) at a specific ratio, as shown in FIG. 3. FIG. 3 illustrates that the interval between the global simulation times is set so that it is twice the real-time interval d₁, which is merely an example.

Meanwhile, each of the plurality of distributed simulators 200a to 200n sends information about the minimum time interval between global simulation times, which is required to analyze the continuous or discrete elements of a subsystem model allocated thereto, to the global time setting unit 120. The global time setting unit 120 sets the time interval d₂ between the global simulation times to a time interval that is equal to or longer than a time interval sufficient for all the distributed simulators 200a to 200n to analyze the continuous or discrete elements, based on information about the minimum time intervals between the global simulation times that are received from the plurality of distributed simulators 200a to 200n.

The global time distribution unit 140 distributes the global simulation time set by the global time setting unit 120 over the plurality of distributed simulators 200a to 200n. In this case, the global time distribution unit 140 distributes a current global simulation time GTᵢ over the plurality of distributed simulators 200a to 200n, and then distributes a global simulation time GTᵢ₊₁, that is, a global simulation time subsequent to the current global simulation time GTᵢ, over the plurality of distributed simulators 200a to 200n at the time interval d₂. Meanwhile, the global time distribution unit 140 may send information about the time intervals d₂ between the global simulation times, together with the current global simulation time GTᵢ, to the plurality of distributed simulators 200a to 200n.

FIG. 4 is a block diagram showing the construction of each of the plurality of the distributed simulators 200a to 200n that form the system for performing distributed simulation, which is shown in FIG. 1.

All the plurality of distributed simulators 200a to 200n that form the system for performing distributed simulation according to the present invention have the same construction, and perform the same function. Accordingly, one of the distributed simulators 200 will be described below by way of example in order help an understanding of the present invention.

Referring to FIG. 4, the distributed simulator 200 according to the present invention includes a simulation task scheduling unit 220, a local time determination unit 240, and a simulation execution unit 260.

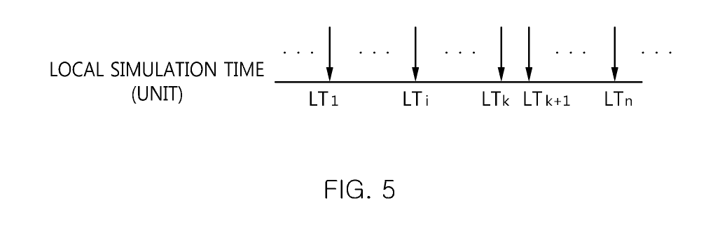

The simulation task scheduling unit 220 calculates a global simulation time GTᵢ₊₁ subsequent to a current global simulation time GTᵢ based the current global simulation time GTᵢ and information about the time interval d₂ between the global simulation times distributed by the simulation time provision apparatus 100, and schedules tasks (i.e., tasks for analyzing the continuous or discrete elements of a subsystem model allocated to the distributed simulator), the simulation of which needs to be performed during the time interval between the current global simulation time GTᵢ and the subsequent global simulation time GTᵢ₊₁. The tasks scheduled by the simulation task scheduling unit 220 are performed based on the local simulation times of each distributed simulator 200. If the local simulation times of the distributed simulator 200 are represented as shown in FIG. 5, the tasks that need to be performed during the time interval between the current global simulation time GTᵢ and the subsequent global simulation time GTᵢ₊₁ may be performed within respective time intervals between local simulation times LT₁ and LTₖ, and tasks that need to be performed during the time interval between the subsequent global simulation time GTᵢ₊₁ and a subsequent global simulation time GTᵢ₊₂ may be performed within respective time intervals between local simulation times LTₖ₊₁ and LTₙ.

The local time determination unit 240 adjusts the interval between local simulation times, during which the continuous or discrete elements of an allocated one of subsystem models that model subsystems forming a hybrid system will be analyzed, based on the global simulation time that is distributed by the simulation time provision apparatus 100 in synchronization with the real time.

That is, the local time determination unit 240 adjusts the intervals between the global simulation times during which the tasks are performed by determining whether a current local simulation time LTᵢ at which tasks that need to be performed during the time interval between the current global simulation time GTᵢ and the subsequent global simulation time GTᵢ₊₁ start is between the current global simulation time GTᵢ and the subsequent global simulation time GTᵢ₊₁. In this case, the local time determination unit 240 may receive the subsequent global simulation time GTᵢ₊₁ from the simulation task scheduling unit 220, or may calculate the subsequent global simulation time GTᵢ₊₁ based on the current global simulation time GTᵢ and information about the time interval d₂ between the global simulation times that are distributed by the simulation time provision apparatus 100.

If, as a result of the determination, it is determined that the current local simulation time LTᵢ is between the current global simulation time GTᵢ and the subsequent global simulation time GTᵢ₊₁, the local time determination unit 240 maintains the time interval between the local simulation times. In contrast, if, as a result of the determination, the current local simulation time LTᵢ is earlier than the current global simulation time GTᵢ, the local time determination unit 240 increases the time interval between the local simulation times, during which the tasks are performed. The local time determination unit 240 transfers the current local simulation time LTᵢ to the simulation execution unit 260, and transfers the subsequent local simulation time LTᵢ₊₁ to the simulation execution unit 260 at the adjusted time interval between the local simulation times.

The simulation execution unit 260 analyzes the continuous or discrete elements of a subsystem model allocated to the distributed simulator 200, and performs simulation on the subsystem model based on the analyzed continuous or discrete elements. The simulation execution unit 260 receives the current local simulation time LTᵢ from the local time determination unit 240, and starts to perform a task for analyzing the continuous or discrete element that needs to be performed at the received current local simulation time LTᵢ. In this case, the simulation execution unit 260 performs the task during the adjusted time interval between the local simulation times, which has been adjusted by the local time determination unit 240.

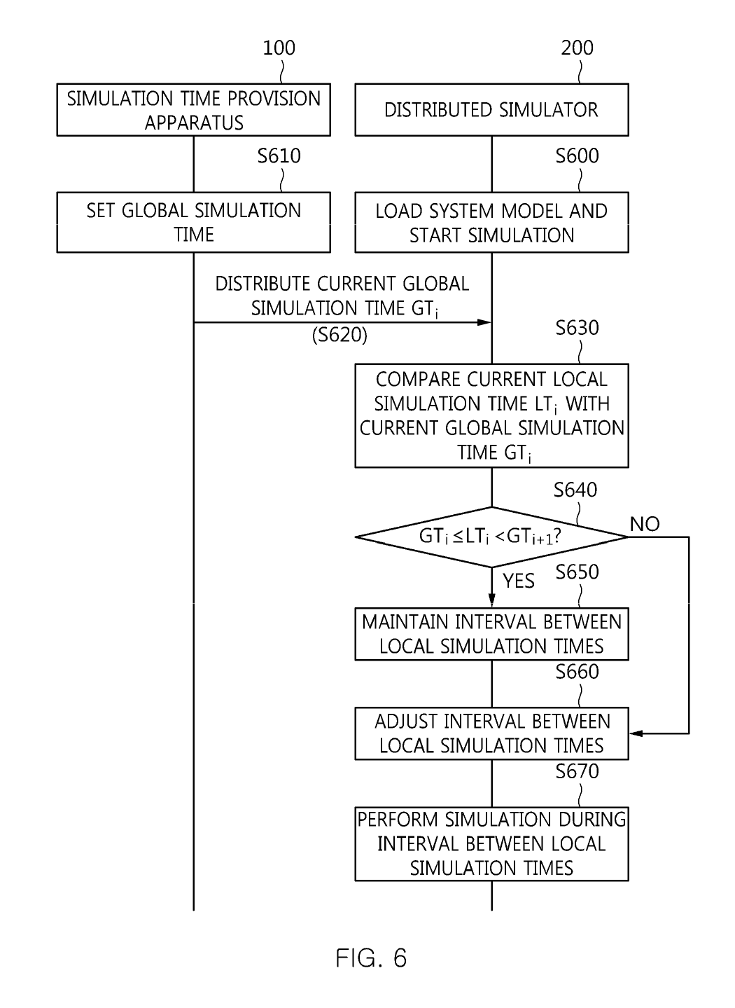

A method of performing distributed simulation according to the present invention will be described below with reference to FIG. 6. First, descriptions that are identical to those of the operation of the simulation time provision apparatus and the distributed simulators forming the system for performing distributed simulation according to the present invention, which have been given with reference to FIGS. 1 to 5, will be omitted.

FIG. 6 is a flowchart illustrating the method of performing distributed simulation according to the present invention.

Referring to FIG. 6, in the method of performing distributed simulation according to the present invention, first, the distributed simulator 200 loads a subsystem model allocated thereto onto the simulation execution unit 260 and starts to perform simulation on the subsystem model at step S600.

Thereafter, the simulation time provision apparatus 100 sets global simulation time synchronized with real time at step S610. At step S610, the global time determination unit 120 of the simulation time provision apparatus 100 sets the global simulation time so that the global simulation time has a specific time interval d₂ that is proportional to a real-time interval d₁ at a predetermined ratio received from an external system or a user.

Thereafter, at step S620, the simulation time provision apparatus 100 distributes the global simulation time that is set at step S610. In this case, at step S620, the simulation time provision apparatus 100 distributes a current global simulation time GTᵢ over the distributed simulators 200 based on the global simulation time set at step S610. Meanwhile, after distributing the current global simulation time GTᵢ, the simulation time provision apparatus 100 may distribute a subsequent global simulation time GTᵢ₊₁ over the distributed simulators 200 at the time interval d₂.

Thereafter, at step S630, the distributed simulator 200 compares the current local simulation time LTᵢ at which tasks for analyzing the continuous or discrete elements of the subsystem that needs to be performed during the time interval between the current global simulation time GTᵢ and the subsequent global simulation time GTᵢ₊₁ start, with the current global simulation time GTᵢ that is received from the simulation time provision apparatus 100 at step S620.

Thereafter, the distributed simulator 200 determines whether the current local simulation time LTᵢ is between the current global simulation time GTᵢ and the subsequent global simulation time GTᵢ₊₁ at step S640. If, as a result of the determination at step S640, it is determined that the current local simulation time LTᵢ is between the current global simulation time GTᵢ and the subsequent global simulation time GTᵢ₊₁, the distributed simulator 200 maintains the time interval between the local simulation times at step S650. At step S640, the distributed simulator 200 may calculate the subsequent global simulation time GTᵢ₊₁ based on the current global simulation time GTᵢ and information about the time interval d₂ between the global simulation times, which is distributed by the simulation time provision apparatus 100.

If, as a result of the determination at step S640, it is determined that the current local simulation time LTᵢ is not between the current global simulation time GTᵢ and the subsequent global simulation time GTᵢ₊₁, the distributed simulator 200 adjusts the time interval between the local simulation times at step S660. More particularly, if the current local simulation time LTᵢ is earlier than the current global simulation time GTᵢ, the distributed simulator 200 increases the time interval between the local simulation times.

Finally, the simulation execution unit 260 performs the task for analyzing the continuous or discrete elements of the subsystem that needs to be performed during the time interval between the current global simulation time GTᵢ and the subsequent global simulation time GTᵢ₊₁, during the interval that is maintained at step S650, or during the interval that is adjusted at step S660.

As described above, the present invention is advantageous in that a designer can easily check whether a designed hybrid system has been configured as intended because the developer can perform simulation on a system model in order to ensure the reliability of a system upon designing a hybrid system, such as a CPS.

Furthermore, the present invention is advantageous in that a plurality of distributed simulators can perform distributed simulation in real time because a real-time synchronization function is provided to the distributed simulators in the distributed simulation environment of a hybrid system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A simulation time provision apparatus, comprising:
a global time setting unit configured to set global simulation times synchronized with real times based on the real times; and
a global time distribution unit configured to distribute the global simulation times over a plurality of distributed simulators that perform simulations on respective subsystem models that model subsystems that form a hybrid system.

2. The simulation time provision apparatus of claim 1, wherein the global time setting unit sets the global simulation times having a specific time interval that is proportional to a real-time interval at a predetermined ratio.

3. The simulation time provision apparatus of claim 2, wherein each of the plurality of distributed simulators adjusts an interval between local simulation times, during which continuous or discrete elements of its allocated subsystem model will be analyzed, based on the global simulation times.

4. A distributed simulator, comprising:
a local time determination unit configured to adjust an interval between local simulation times, during which continuous or discrete elements of an allocated one of subsystem models that model subsystems forming a hybrid system will be analyzed, based on global simulation times synchronized with real times and distributed by a simulation time provision apparatus; and
a simulation execution unit configured to perform simulation to analyze the continuous or discrete elements of the subsystem model during a period corresponding to the adjusted interval between the local simulation times.

5. The distributed simulator of claim 4, wherein the local time determination unit adjusts an interval between the global simulation times by comparing a current global simulation time distributed by the simulation time provision apparatus with a current local simulation time at which the analysis of the continuous or discrete elements, a simulation for which is scheduled to be performed at the current global simulation time, starts.

6. The distributed simulator of claim 5, wherein the local time determination unit increases the interval between the global simulation times if the current local simulation time is earlier than the current global simulation time.

7. The distributed simulator of claim 5, wherein the local time determination unit maintains the interval between the local simulation times if the current local simulation time is later than the current global simulation time and is earlier than a global simulation time that is distributed after the current global simulation time has been distributed.

8. A method of performing distributed simulation, comprising:
setting, by a simulation time provision apparatus, global simulation times synchronized with real times based on the real times;
distributing, by the simulation time provision apparatus, the set global simulation times over distributed simulators;
adjusting, by each of the distributed simulators, an interval between local simulation times, during which continuous or discrete elements of an allocated one of subsystem models that model subsystems forming a hybrid system will be analyzed, based on the global simulation times; and
performing, by the distributed simulator, simulation to analyze the continuous or discrete elements of the subsystem model during a period corresponding to the adjusted interval between the local simulation times.

9. The method of claim 8, wherein setting the global simulation times synchronized with the real times comprises setting the global simulation times having a specific time interval that is proportional to a real-time interval at a predetermined ratio.

10. The method of claim 9, wherein distributing the set global simulation times over the distributed simulators comprises distributing a current global simulation time and information about the interval between the global simulation times over the distributed simulators.

11. The method of claim 10, wherein adjusting the interval between the local simulation times comprises adjusting the interval between the local simulation times by comparing the current global simulation time with a current local simulation time at which the analysis of the continuous or discrete elements, a simulation for which is scheduled to be performed at the current global simulation time, starts.

12. The method of claim 11, wherein adjusting the interval between the local simulation times comprises increasing the interval between the local simulation times if the current local simulation time is earlier than the current global simulation time.

13. The method of claim 11, wherein adjusting the interval between the local simulation times comprises maintaining the interval between the local simulation times if the current local simulation time is later than the current global simulation time and is earlier than a global simulation time that is distributed after the current global simulation time calculated based on the information about the interval between the global simulation times has been distributed.
